(19) United States
(12) Patent Application Publication
(10) Pub. No.: US 2018/0144367 A1
(43) Pub. Date: May 24, 2018

(54) METHOD AND SYSTEM FOR CREATING USER BASED SUMMARIES FOR CONTENT DISTRIBUTION

(71) Applicant: 140 Proof, Inc., San Francisco, CA (US)

(72) Inventors: Jon Elvekrog, San Francisco, CA (US); John Manoogian, San Francisco, CA (US); Erik Michaels-Ober, San Francisco, CA (US)

(21) Appl. No.: 15/823,690

(22) Filed: Nov. 28, 2017

Related U.S. Application Data
(63) Continuation of application No. 15/160,153, filed on May 20, 2016, now abandoned.
Application No. 15/160,153 is a continuation of application No. 14/196,683, filed on Mar. 4, 2014, now abandoned.
Application No. 14/196,683 is a continuation of application No. 12/820,074, filed on Jun. 21, 2010, now abandoned.
(60) Provisional application No. 61/289,982, filed on Dec. 23, 2009.

(51) Int. Cl. G06Q 30/02; H04L 29/08; H04L 12/58; G06Q 50/00

(52) U.S. Cl. CPC G06Q 30/0256; H04L 67/306; H04L 67/02; H04L 51/32; G06Q 30/0277; G06Q 30/02; G06Q 30/0269; G06Q 30/0255; G06Q 30/0201; G06Q 50/01

(57) ABSTRACT

A method and system for serving advertisements to a user of a social network, the social network being an internet based web platform with a plurality of user accounts, including creating a user summary by extracting implicit user attributes from a user account of the social network; creating a plurality of advertisement summaries composed in a format shared by the user summary; comparing the user summary to an advertisement summary to calculate a similarity score; and serving an advertisement to the user based on criteria related to the similarity score.

### CROSS-REFERENCE TO RELATED APPLICATIONS

This application is a continuation of U.S. patent application Ser. No. 15/160,153, filed 20 May 2016, which is a continuation of Ser. No. 14/196,683, filed 4 Mar. 2014, which is a continuation of U.S. patent application Ser. No. 12/820,074, filed 21 Jun. 2010, which claims the benefit of U.S. Provisional Application No. 61/289,982, filed 23 Dec. 2009, both which are incorporated in their entirety by this reference.

### TECHNICAL FIELD

This invention relates generally to the social network advertising field, and more specifically to a new and useful method and system in the social network advertising field.

### BACKGROUND

The use of social networking on the internet has seen a surge in use in recent years. Despite an increase in personal information and knowledge of what an individual user is doing, providing personalized content to a user has continued to be a problem. To compound this problem, content streams such as Twitter and Facebook feeds are a growing form of social networking. The highly dynamic and short nature of such content streams makes targeting content for user consumption difficult. Instead of users actively seeking information, information is being pushed to users through content streams. Many advertisement methods rely on delivering content such as advertisements based on keyword searches, user tracking, or user information supplied by the user, but such methods do not translate to content streams and other newer forms of social network interaction. In particular, advertisers have failed to find solutions to provide advertisements to users that they wish to target. Thus there is a need in the field to create a new and useful system and method. This invention provides a new and useful method and system for creating user based summaries for content distribution.

### BRIEF DESCRIPTION OF THE FIGURES

FIG. 1 is schematic representation of a method of the preferred embodiment of the invention;

FIG. 2 is a flowchart representation of a method of the preferred embodiment of the invention;

FIG. 3 is a detailed schematic representation of creating a user summary;

FIGS. 4A-4C are exemplary schematic representations of creating an advertisement summary;

FIGS. 5A-5B are exemplary schematic representations of variations of comparing a user summary to an advertisement summary through a persona summary;

FIG. 6 is a schematic representation of a system of the preferred embodiment of the invention; and

FIG. 7 is a schematic representation of the advertisement system of the system of FIG. 6.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Method for Distributing Content by User and Advertisement Summaries

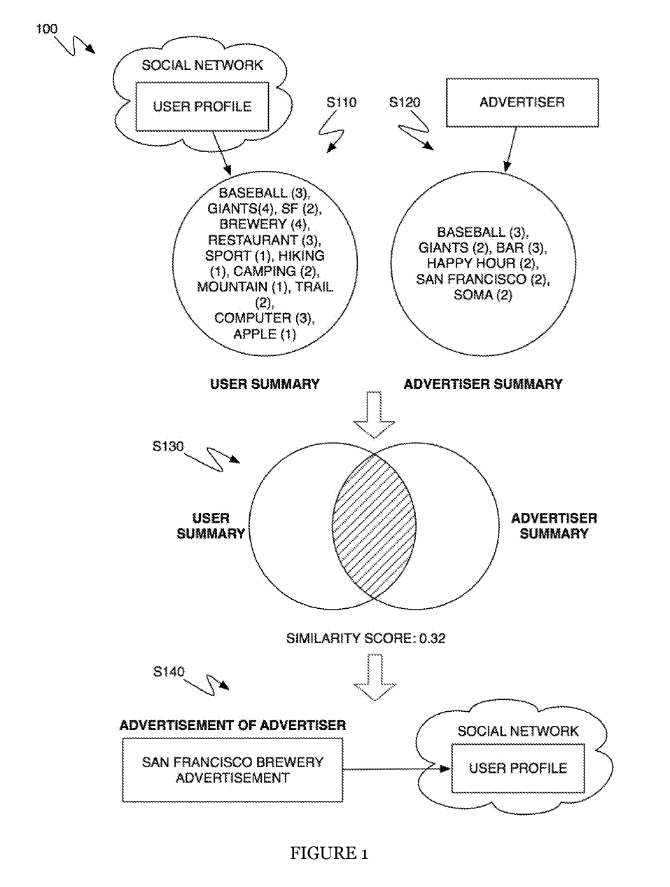

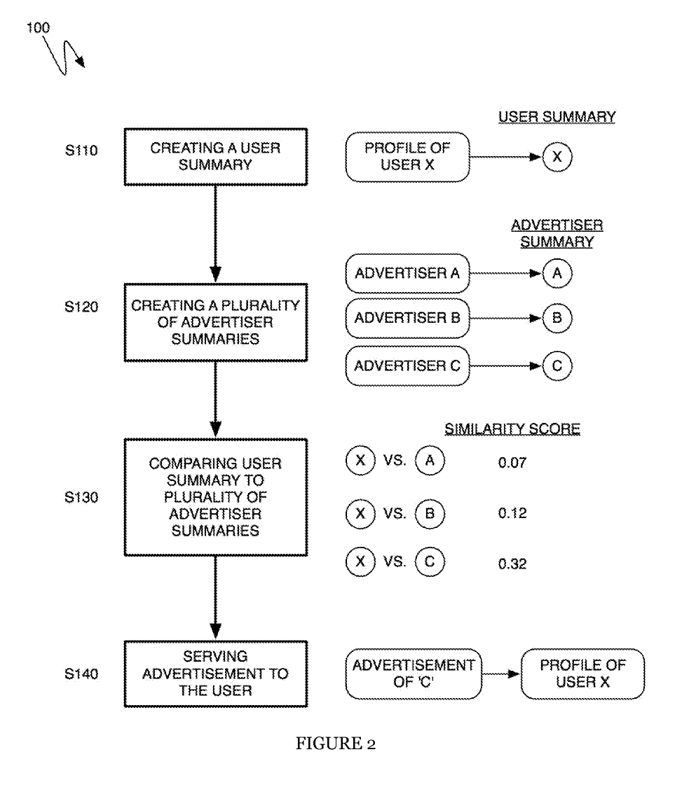

As shown in FIGS. 1 and 2, the method 100 for distributing content by user and advertisement based summaries of the preferred embodiment includes creating a user summary from implicit persona attributes of a user account S110, creating a plurality of advertisement summaries S120, comparing the user summary to an advertisement summary to create a similarity score S130, and serving an advertisement to the user based on a set criteria S140. The method 100 functions to create a unique descriptor of the interests of a user through the behavior of the user on a social network and applying this descriptor to provide customized content to the user. The method 100 is preferably applied for serving advertisements, but may alternatively be used for providing any suitable type of content such as content recommendations or social network connection suggestions. The method 100 is preferably applied to social networks where a user has a personal profile with connections to other users and entities. The social network is preferably an internet based web platform with a plurality of user accounts where the users establish social network connects through social network participation. The social network connections preferably includes connections to individual people but may additionally include connections to organizations, companies or any suitable entity. More preferably, the method is applied to a content stream based social network where a user consumes, interacts, and creates content through blogging, status updates, and media sharing such as on Twitter or the Facebook feed. A content stream is preferably any internet service that feeds content in a substantially real-time fashion. A content stream is preferably organized chronologically and contains micro-blog posts with a user communication protocol for carrying on a conversation within the content stream. The individual messages on a content stream are preferably text based and typically short in length (e.g., 140 characters). The individual messages or posts may alternatively include any suitable media. The content on a content stream additionally is preferably pulled from a variety of social network contacts of a user, and preferably does not require active participation of a user to see new content through the content stream. New content is typically pushed to users when accessing the social network. The method is preferably applied to provide advertisements for the plurality of users of a social network. The method 100 may be implemented within a social network site, through a social network site, as an API for application clients or websites, or in any suitable form.

### 1.1 Creating a User Summary of Weighted Keywords

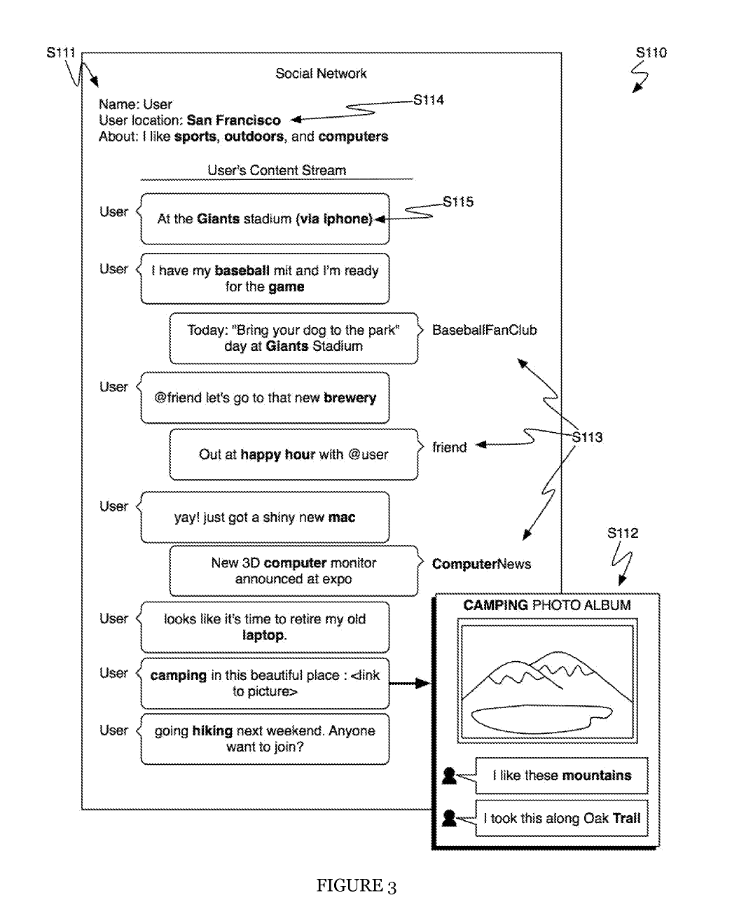

As shown in FIG. 3, Step S110, which includes creating a user summary from implicit persona attributes of a user account, functions to create a user data representation or descriptor from the perceived interests and characteristics of the user. The user summary is preferably extracted from implicit persona attributes of a user account and more preferably a content stream. Implicit persona attributes preferably describe characteristics that are apparent through the manner in which the social network is used by the user. A user summary preferably does not rely on the user being an active participant on the social network where active describes creating content, rating content, interacting with content, or any suitable action. By having an account with social connections, the user preferably creates a social stream that is populated by content created by the social connections. The information contained within the whole of the social stream preferably includes implicit information from which characteristics of a user may be collected. The implicit information is preferably obtained through the content created by users that the user has decided to follow. The social stream of a user is preferably typically unique in that the user selects which users and entities to form a social network connection with or to follow. For example, a user following several professional baseball players may never actively state in the profile that the user has an interest in baseball, but extracting the implicit information from the user account would preferably indicate that baseball is an interest of the user. The user summary may additionally use explicit information such as content generated by the user or profile information such as location and interests.

The user summary is preferably a collection of weighted keywords. The user summary may alternatively be any suitable data format such as a list of ratings for a standard set list of attributes for which any persona may be defined. A user summary is preferably composed of a plurality of vector parameters that cooperatively define characteristics of a user. Vectors are preferably different metrics of specifying aspects of user characteristics. Preferably, the vectors include keywords, location, followship (i.e., who the user follows and/or the type of entities the user follows), influence (i.e., number and/or type of followers or friends), mentions (i.e., the number of times the person is discussed by others), demographic, dislikes (e.g., concepts not of interest) and/or any suitable descriptor of a persona. A vector parameter is preferably the variable value for a particular vector. For example, a location vector may have a parameter of ‘San Francisco’ and an interest vector may have a parameter of ‘baseball’. A keyword is preferably a term or tag that is associated with or assigned to a central concept or piece of information. A group of terms may be associated with a single keyword. These terms preferably do not have to be derived from the same word root. The assignment of a term to a keyword may be algorithmically created or pre-assigned within the system. For example, the terms “Giants”, “golden gate bridge”, “market St.” may be grouped with the keyword “San Francisco”. Canonical forms of words are preferably additionally recognized. For example, “NYTimes” and “New York Times” would be recognized as the same term and generate an instance of the same keyword. Terms or text may additionally be used to generate multiple keywords. From the earlier example, the term “Giants” may be used to generate an instance of the keyword “San Francisco” and “Baseball”. Keywords may additionally be hierarchical keywords where a keyword may have a parent concept, such as “San Francisco” and “California”. The keywords are preferably derived from content generated by the user and/or the content the user interacts with on a social network. In creating the user summary of weighted keywords, keywords are preferably first identified within content of the social network that the user has interacted with, based on grouping and priority rules keywords are assigned to the user summary, and then weighting is applied to keywords according to how strongly they correlate to a user description (e.g., based on frequency of occurrence). More preferably, the keywords are derived from content of a social network stream.

As shown in FIG. 3, the creation or formation of a user summary is preferably composed of at least one of the sub-steps: extracting information from a user profile S111, extracting information from referenced sources S112, analyzing social network connections S113, analyzing location information S114, and/or determining social network tools of the user S115. In creating a user summary, the above sub-steps and any suitable alternative steps may be used in any suitable combination. The weighting of keywords or persona attributes is preferably applied to keywords based on the amount of presence the keywords have in the user profile. This is preferably based on frequency of the keyword, predefined weighting factors for terms, statistically improbability (similar to the statistically improbable phrases used by the Amazon search engine), or any suitable metrics of the importance of a keyword when describing a user. Additionally, the user summary is updated periodically. Future analysis of a user preferably enhances the user summary by adding keyword data, but may alternatively entirely refresh the user summary creating a new user summary from the most recent information. For example, the system may use two separate methods for building a user profile, one that can be executed with no prior knowledge of the user and therefore responds rapidly, and one that performs an analysis over a much larger data set and updates the user summary over time.

Step S111, which includes extracting information from a user profile, functions to analyze the personal information created by or sent to the user. This preferably applies to status updates of a content stream (e.g., micro-blogging), but may additionally be applied to profile information such as static information on interests, favorite movies, an “about” section, or any suitable content of a user profile on a social network. A substantially large sampling of the content stream of the user (e.g., status updates of entities with an established social network connection to the user) is preferably analyzed and keywords or themes of the contents are extracted using regular expression processing. This preferably includes updates from content by other users but may additionally include content created by the user. First, main terms are preferably identified by searching the text for capitalized words and excluding word tokens which are all capitalized, because these are assumed to be acronyms. Then, short words less than a minimum length are preferably eliminated, along with commonly used words, which are defined in a commonly-used words table. The main terms contained within the content steam are preferably identified as instances of keywords. The status updates are preferably short and concise, sometimes with a character limit such as on Twitter, and thus status updates written by a user generally have a focused theme or context. Keywords extracted from a single status update or post preferably describe the general idea of the post without the syntactical structure of the actual post. In addition to analysis of written text by the user, tags or hashtags, labels, categorization, titles, or any suitable user generated “keyword” may be used as a keyword. Before being assigned to a user summary, keywords may additionally have to meet some requirements, such as a minimum instance frequency within the user profile. Additionally or alternatively, particular keywords may be marked for significance and any suitable occurrence may cause a keyword to be associated with the user summary. For example, on a website such as Twitter, users post frequent short status messages in text form. Those messages can be concatenated together, all words sorted by frequency and importance via semantic analysis, e.g., by searching for proper nouns, and then scored. Content created by other users may receive a lower weighting or score to account for the weaker signal since the keywords were not generated by the user but any suitable weighting may be used.

Step S112, which includes extracting information from referenced sources, functions to use outside content to identify interests and keywords to associate with a user summary. The referenced sources are preferably web links (e.g., universal resource identifiers or URIs) or media files such as photos, music, or video. The web links may direct a visitor to a site outside of the social network, but may be references (links) to other portions of the social network (such as to a photo album hosted on the social network). Preferably, the site referenced by the link is fetched, and the contents of the page scraped or analyzed to generate keywords. In one variation, the title section of the page is returned and artificially inserted in the post containing the link as a way to summarize the link contents. The extraction of keywords from a user profile is preferably performed after inserting a link summary into the post. This page content insertion functions to create a textual description of the link, which can be analyzed in the same process as other content of the user profile (as opposed to the URI which would generally not be interpretable by a regular expression analyzer). Additionally or alternatively, the content of the site may be scraped. Text, media, links within the reference may all be used to establish keywords. Special case rules may be created for websites that follow basic patterns (and that are often referenced). The special case rules preferably instruct the system where to extract information from on the page. For example, on a popular photo sharing site, the title of the photo or of the photo album be analyzed for keywords. Referenced sources are preferably analyzed for ones that are shared by social connections of the user or the user shares, but the referenced content may alternatively or additionally be analyzed or more strongly weighted when the referenced content is interacted with by the user. Examples of such situations include when a user visits the link shared by another user or comments on a post with referenced content. Commenting preferably includes the actions of replying, rating, forwarding (retweeting or sharing), or any suitable action that connects the user with the post containing the referenced content.

Step S113, which includes analyzing social network connections, functions to use the relationships established within a social network to characterize a user. A social connection is preferably a connection that a user voluntarily establishes with another user or entity such as by following, friending, becoming a fan, joining a group, or any suitable action that establishes a connection with another entity on the social network. Particularly in the case of subscribing to the content stream of other users, the other users preferably have a strong correlation to the interests of the user, and so the keywords associated with the other users are preferably applied to the user. In one variation, the other user also has a user summary generated by the system and keywords that describe the other user may be applied to the first user. The keywords of the other user may alternatively influence the weighting of keywords of the first user. As another variation, popular entities on the social network, such as celebrities or groups with a large number of followers or fans, may have predefined keywords associated with them. So for example, following the content stream of a professional basketball player may cause “basketball” to be used as a keyword for the user. Additionally, users may group entities that they follow such as by placing followees in lists. The names of the lists may additionally be used as descriptors for the people included in those lists. For a user that is associated with a group of keywords, friends of that user will also received the same keyword associations, albeit preferably at a lower score. This sharing of keywords across social networks is based on “birds of a feather association” that indicates a powerful shared preference based on a social connection. For an example of this behavior, friends who share an interest and a social network connected are much more likely to respond positively to a similar “basketball shoe” advertisement than users who share similar demographic data, but are not social network connected.

Step S114, which includes analyzing location information, functions to use additional geographical information to assign a keyword or attribute to the user. In many micro-blogging platforms, location information is assigned to individual posts made by a user. An accurate understanding of where a user resides can be derived from this individual post location information. Patterns may additionally be identified so that time of day has a correlation to location such as where they are during business hours (e.g., location of office) and where they are at night (e.g., location of home). Additionally, irregularities in location may indicate the user is on vacation or a business trip. Keywords associated with such detected patterns may be assigned to a user summary (e.g., “Tahiti vacation”). As yet another addition, particular locations may have keywords associated with them. For example, when location information indicates the user is at a baseball stadium the keyword “baseball” may be identified for that post. These location-based keywords may additionally be personalized for individual users if the keywords generated by a user at a particular location occur frequently. Alternatively, location information may be acquired from static information from the user profile.

Step S115, which includes determining social network tools of the user, functions to identify applications or hardware that a user uses to interact with the social network. In many micro-blogging platforms, the application or hardware from which a post is sent is included as part of the post. In some situations, this may be used to identify the type of hardware (if an application is specific to a particular type of hardware) such as for a mobile phone, a computer operating system, a browser, a gaming device, or any suitable device. Some software applications include integration with social networks such as games that post scores (e.g., “MS X-Box”). Software applications using such integration may additionally be identified. In an online social network, such as Twitter, with many possible applications for posting updates, each of those applications might display a “source” identifying the application. By defining a mapping table of applications to keywords lists, the system can associate relevant keywords with posts from that application. For example, given an application named “Birdfeed” that only operates on a limited hardware and software platform like the Apple iPhone, the keyword list would include “apple, iphone, mobile” because of the context. Keywords associated with the specific social network tools are preferably included as keywords of the user.

### 1.2 Creating Advertisement Summaries of Weighted Keywords

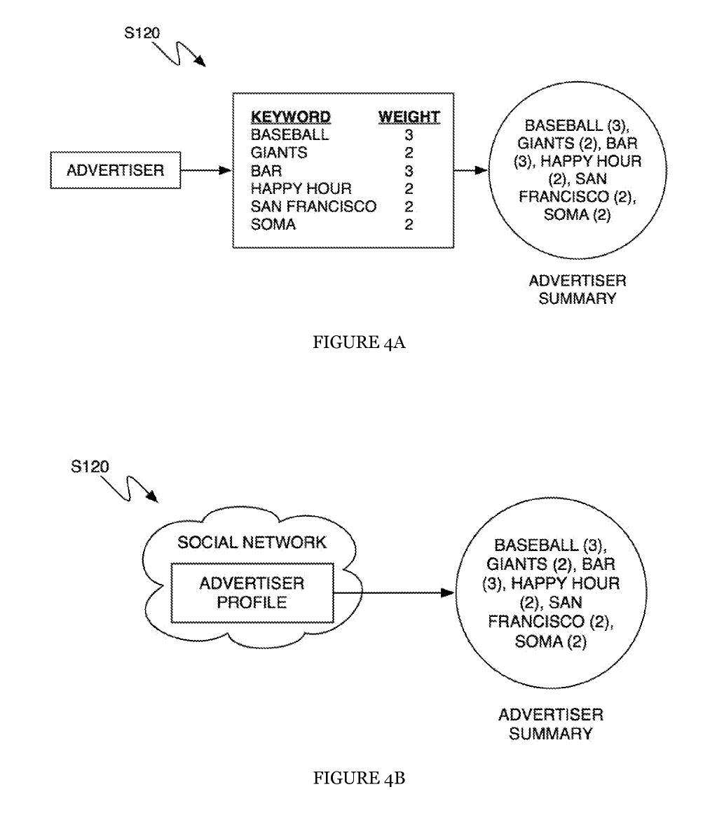

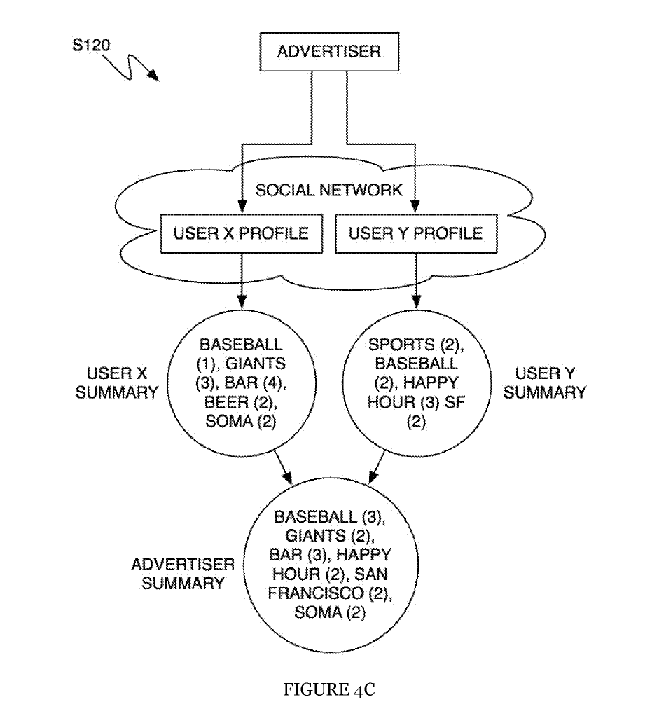

Step S120, which includes creating a plurality of advertiser summaries, functions to setup a data representation of what an advertiser or content distributor wants to be targeting when distributing content. An advertiser is preferably an entity that wishes to serve advertisements to a user, but alternatively the advertiser may be a content provider or any party that wishes to feed targeted content to a user including promoted content, suggested social connections, media, or any suitable form of content. An advertisement summary is preferably a weighted list of keywords substantially similar to a user summary described above. Similar to the user summary, the advertisement summary may alternatively be any suitable data format such as list of ratings for a standard set list of attributes for which any target persona may be defined. The user summary and an advertisement summary preferably have similar formats. Preferably the format is identical with an advertisement summary preferably composed of a plurality of vector parameters that cooperatively define targeted characteristics of an advertiser. The advertisement summary may be formed in a variety of ways. As a first variation, as shown in FIG. 4A, the advertiser may select keywords that the advertiser wishes to target for content distribution. These keywords may be bid on by advertisers, and the weighting of words may additionally be selected by an advertiser. In a second variation, as shown in FIG. 4B, the advertisement summary is preferably formed in substantially the same way as the user summary, by extracting keywords from a social network profile of the advertiser or alternatively from an outside web site. In this variation, the advertisement(s) of the advertiser may be used as the source for keyword extraction. In yet another variation, the advertiser may select a user that functions as prototype user for whom the advertiser wants to target. The advertiser may additionally select a plurality of prototype users, as shown in FIG. 4C. The user summaries of the plurality of prototype users are preferable merged to form a single advertisement summary. The prototype users may be real users or simulated users (fabricated as a model user the advertiser wishes to target). As an additional variation, the advertisement summary is preferably formed by analyzing the followers of an advertiser selected entity. The followers of the entity preferably describe users that have an interest in that entity. The entity may be the social network account of the advertiser, a product, a celebrity (such as a celebrity endorsing an advertised product), a club, or any suitable entity.

### 1.3 Comparing the Summaries to Create a Similarity Score

Step S130, which includes comparing the user summary to an advertisement summary to create a similarity score, functions to identify similarities in the keywords of a user summary and advertiser summaries. A similarity score is preferably calculated by identifying shared keywords and is a metric of the correlation or “match” between a user and an advertiser. More shared keywords preferably results in a higher similarity score. The weighting of keywords is preferably factored into the similarity score. Shared keywords with more weight preferably result in a greater similarity score. Additionally, keywords may include a hierarchical structure for the user summary and an advertisement summary. The level of matching within the hierarchical keyword structure may additionally impact the similarity score. For example, a user summary may include the keyword “basketball” and an advertisement summary may include the keyword “baseball”, but the similarity score may be positively impacted by these different keywords because they both reside within the parent keyword of “sports”. The hierarchical structure of keywords may additionally be used for faster comparison of the user summary with an advertisement summary. The advertisement summaries may additionally include particular restrictions. The restrictions are preferably set for particular vectors. For example, a user summary location vector may be required to match the same geographical location of a particular advertisement summary.

In one variation, upon first encounter of a user, an untargeted advertisement is initially served. The user summary is preferably created after encountering the user, and the similarity scores of a user and a plurality of advertisements is preferably calculated. This preferably creates a prioritized list of advertisements. Upon the next encounter of the user, the highest prioritized advertisement (typically the one with the highest similarity score) is preferably served to the user. New advertisements may have a similarity score calculated at any suitable time after this and added to the prioritized list, because preferably the bulk of the similarity calculation has been performed. Additionally, after a particular advertisement has made an impression, the similarity score may be altered for that advertisement (and related advertisements) may be made according to the reaction of the user. In another variation, the user summaries and similarity scores for a plurality of advertisements may be pre-calculated or calculated based on any suitable event.

In another variation, when creating the user summary and the plurality of advertisement summaries, the method may include relating the user summary to a persona and relating an advertisement of the plurality of advertisement summaries to a persona. The persona preferably functions as a generalization of user characteristics that can preferably be used for scaling a system. A persona is preferably a data descriptor for a plurality of different users that share similar characteristics. The user persona is preferably an overall descriptor. The personas are preferably formatted in a substantially similar format as the user summary and an advertisement summary. But the persona may have any suitable format. A user persona may alternatively generalize aspects of a user summary (e.g., a user persona for an interest in sports) and there may be a plurality of user personas associated with each user summary for each general interest of the user. The personas may additionally be hierarchically structured so that there are parent-child relationships between general and more specific personas. The persona is preferably substantially similar in format to the user summary and/or advertisement summaries, but the persona is preferably more generic than say a user summary. There are preferably a substantially fixed number of personas (e.g., 100 base personas). The personas may be custom designed to create generic representations of a significant portion of the population. The personas may be hand crafted and stored within the system. The personas may alternatively be algorithmically created to together describe substantially the whole population but with each persona having a size criteria such as a minimum population of associated users.

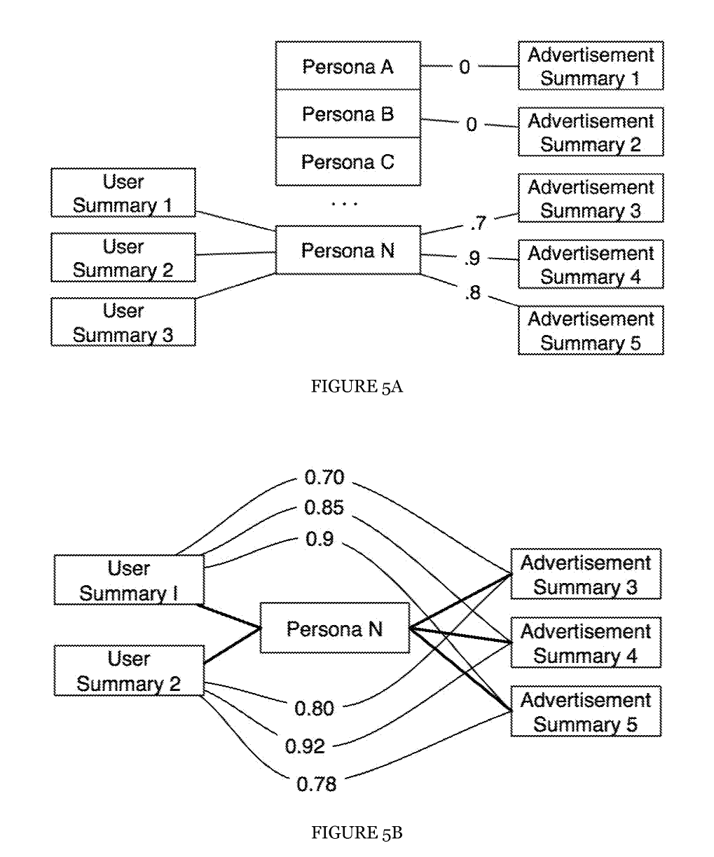

As shown in FIGS. 5A and 5B, the method 100 may additionally or alternatively include comparing the user summary to an advertisement summary through a persona summary, which functions to use a user persona as a comparison intermediary. In one variation shown in FIG. 5A, the similarity score is only computed between personas and advertisements, and then advertisements are preferably served to users of that persona according to a prioritized list. This preferably functions to limit the number of prioritized lists that must be calculated and maintained. For example, if 100 personas are used to characterize the entire population only 100 prioritized lists are preferably be maintained. Additional filtering of advertisements may be performed based on particular vectors such as location. In another variation shown in FIG. 5B, only advertisements and a user summary that share a common persona preferably have a similarity score calculated. This functions to limit the number of advertisements for which a similarity score must be calculated.

### 1.4 Serving an Advertisement to the User Based on a Set Criteria

Step S140, which includes serving an advertisement to the user if the similarity score matches set criteria, functions to send content to a user when a user summary and an advertisement summary are similar to a satisfactory level. The advertisement is preferably selected from a list of advertisements of the advertiser. The criteria may be the best match of a number of advertiser summaries, which would function to send the most appropriate advertisement to a user. The criteria may alternatively be set to select the first advertisement summary with a similarity score beyond a set threshold, which would function to send the first advertisement that would be satisfactorily appropriate for the user. An advertiser may additionally individually set the threshold for the similarity score. This functions to enable advertisers to target users with only a particular level of similarity to their list of keywords. Additionally, an advertisement summary may have corresponding comparison parameters that must be met before an advertiser is selected for is served. Such comparison parameters include the similarity score threshold, a required keyword, a keyword that a user must not contain, a combination of keywords, a particular weighting of a keyword, and/or any suitable criteria. The advertisement is preferably sent to the user through the social network. The advertisement may be displayed on the user profile, within a content stream of the user, or on any suitable portion of the social network.

### 2. System for Creating Keyword Based Summaries for Content Distribution

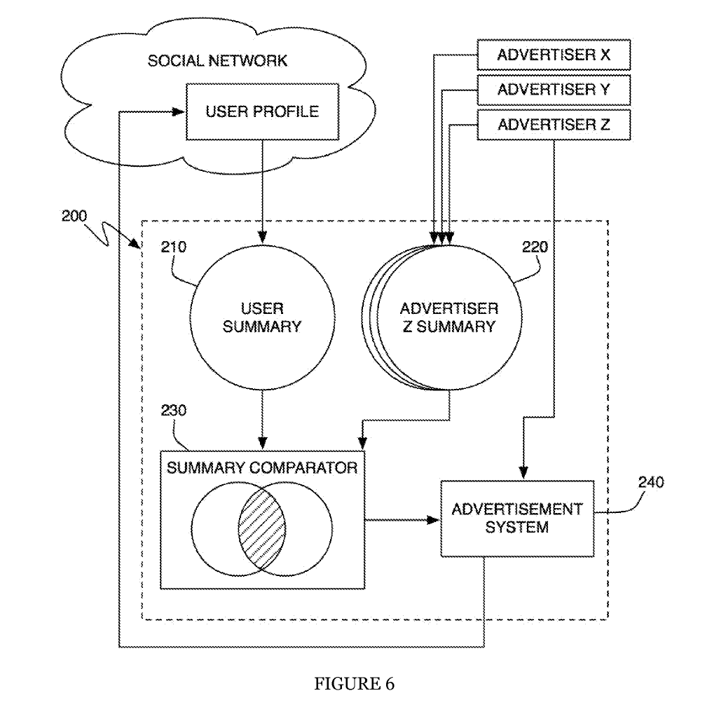

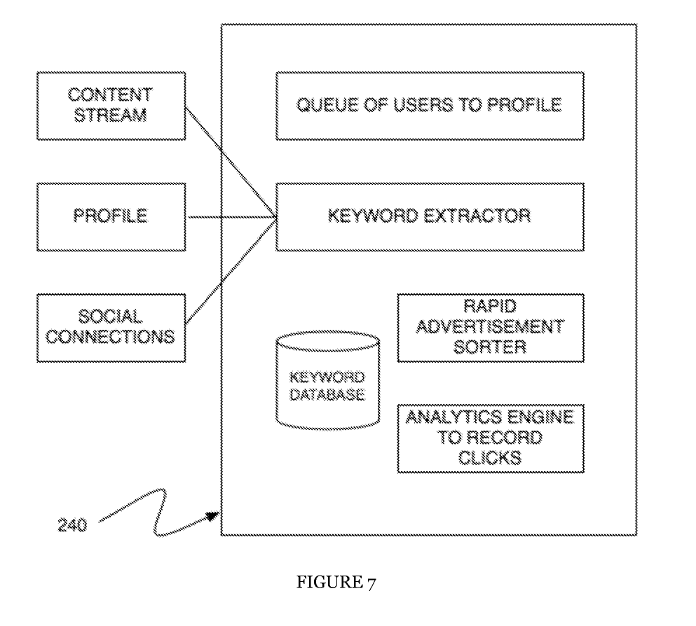

As shown in FIG. 6, a system 200 of the preferred embodiment for creating keyword based summaries for content distribution includes a user summary composed of keywords 210, an advertisement summary composed of keywords 220, a summary comparator 230, and an advertisement system 240. The system functions to create a reduced model of the interests of a user based on interactions within a social network, and then find an advertisement that would be appropriate for the user. The user summary 110 is preferably a list of weighted keywords derived from the profile of a user on a social network. More preferably the user summary no is a list of weighted keywords defined within user summary vectors. The user summary no may alternatively be any suitable format. The keywords are more preferably derived from the posts and content on a social network stream. The keywords are preferably created in a substantially similar fashion as described for the above method 100. The advertisement summary 220 is substantially similar in structure to the user summary 210. The keywords of an advertisement summary 220 may however be selected by an advertiser or generated to target a particular prototype user. The advertisement summary 220 may additionally have comparison parameters that determine criteria that must be satisfied for an advertisement summary to be selected by the summary comparator 230 as the best match for a user summary 230. The advertisement summary 220 preferably additionally has an association to at least one advertisement or content hosted in the advertisement system 240. The summary comparator 230 identifies an advertisement summary that best satisfies the similarity criteria of the system 200. The summary comparator preferably completes the comparison performed in S130 of the above method 100. A persona abstraction may additionally be used to relate a user summary to advertisement summaries. The advertisement system 240 functions to serve an advertisement to the user. As shown in FIG. 7, the advertisement system 240 may include a queue of users to profile, a keyword extractor that extracts from content streams, user profiles, and social connections, a keyword database, a rapid advertisement sorter, and an analytics engine to record clicks (or other suitable actions). The advertisement system 240 may alternatively communicate to an outside advertising service that serves the advertisements. Alternatively, the advertisers may be any suitable content that is targeted at the user.

An alternative embodiment preferably implements the above methods in a computer-readable medium storing computer-readable instructions. The instructions are preferably executed by computer-executable components for creating keyword based summaries for content distribution. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

We claim:

1. A method for serving advertisements in a social network, the social network being a web platform with a plurality of user accounts, the method comprising:
at a computing system:
retrieving a content stream comprising a feed of pushed posts generated by social network connections of each user account on a social network, the social network connections comprising entities selected by the user to follow on the social network;
creating a user summary comprising keyword parameters extracted from implicit user attributes from the content stream for each user account;
receiving an advertisement summary associated with an advertisement from an advertiser that is not followed by the user;
calculating a similarity score between the user summary and the advertisement summary; and
inserting the advertisement into the content stream as a post visible on a second computer based on the similarity score.

2. The method of claim 1, wherein the advertisement summary comprises a set of restriction rules that factor into the calculation of the similarity score, the user summary comprising a plurality of summary vectors comprising location, interests, and followship, each vector having at least one keyword parameter.

3. The method of claim 2, further comprising associating the user summary with a persona; and calculating a similarity score between a user and the advertisement summary by calculating a similarity score between the persona and the advertisement summary.

4. The method of claim 3,
wherein receiving an advertisement summary comprises receiving a plurality of advertisement summaries, each associated with an advertisement; and calculating a similarity score comprises calculating a similarity score between the user summary and each advertisement summary;
the method further comprising ordering the plurality of advertisements into a list of advertisements to be served to the user, based on the associated similarity scores; inserting the advertisement into the content stream comprising:
inserting the advertisement with the highest similarity score in the list into the content stream; and
altering the similarity score for the served advertisement.

5. A method for serving advertisements comprising:
at a first computer, extracting keywords from a content stream associated with a user, the content stream comprising a feed of posts generated by a set of social network connections to which the user is subscribed on the social network;
at the first computer, creating a user summary comprising the extracted keywords and a weight associated with each keyword;
at the first computer, creating an abstract persona from the user summary and a second user summary extracted from a second content stream associated with a second user of the social network;
at the first computer, receiving a plurality of advertisements and associated advertisement summaries from an advertiser outside of the set of social network connections, each advertisement summary comprising one or more keywords;
at the first computer, comparing the abstract persona to each advertisement summary and calculating a similarity score for each advertisement;
at the first computer, compiling a list of advertisements associated with the user, the list of advertisements ordered by similarity score; and
in response to an advertisement request, introducing an advertisement having the highest similarity score from the list by the first computer into the user content stream as a post, the advertisement viewable by the user at a second computer associated with the user; and
at the first computer, adjusting the similarity score of the advertisement.

6. A method for serving advertisements comprising:
at a first computer, identifying social network connections, selected to be followed by a user of a social network, whose content is delivered to a content feed of the user;
at the first computer, extracting one or more user keyword categorizations from the content feed of the user;
at the first computer, creating a user summary for the user comprising the retrieved keywords and an associated weight for each user keyword;
at the first computer, receiving a plurality of advertisement summaries associated with a plurality of advertisements from an advertiser not followed by the user, each advertisement summary comprising one or more weighted vendor keywords;
at the first computer, determining a degree of similarity between the user summary and each advertisement summary by comparing the user summary to each advertisement summary;
at the first computer, ordering the plurality of advertisements by the degree of similarity for the user; and
serving an advertisement selected from the plurality of advertisements, the served advertisement being associated with the advertisement summary with the highest degree of similarity, serving the advertisement comprising inserting the advertisement into the content feed as a post viewable by the user on a second computer.

7. A method of distributing content comprising:
receiving at a first computer a user content stream for each user account of a social network, each user content stream comprising a compiled stream of posts created by a user network specific to the user content stream, the user network comprising a plurality of social network users followed by the user;
at the first computer, creating a user summary for each user account comprising implicit user attributes comprising one or more user keywords extracted from the user content stream associated with the user account;
at the first computer, creating a promotion summary comprising one or more vendor keywords associated with a marketable product or service;
at the first computer, computing a degree of similarity between a user summary and the promotion summary;
at the first computer, receiving a promotional content from a third party advertiser; and
in response to the degree of similarity exceeding a predetermined degree of similarity between a user summary and the promotion summary, delivering the promotional content from the first computer into the user content stream associated with the user summary as a post in the user content stream that is viewable by the user at a second computer associated with the user.

8. The method of claim 7, wherein creating a user summary for each user account comprises: creating a plurality of vectors comprising a user location, a user interest, and a user followship, each of the plurality of vectors comprising at least one keyword.

9. The method of claim 8, wherein creating a user summary for each user account comprises: identifying an entity that the user account follows; identifying an entity keyword associated with the entity; and assigning the entity keyword to the user summary.

10. The method of claim 8, wherein creating a user summary for each user account comprises: identifying a location of the user from the user account; identifying a location keyword associated with the location; and assigning the location keyword to the user summary.

11. The method of claim 8, wherein creating a user summary for each user account comprises: identifying a user interest from the user content stream; identifying an interest keyword associated with the user interest; and assigning the interest keyword to the user summary.

12. The method of claim 7, wherein the promotional content comprises promoted content generated by the third party advertiser.

13. The method of claim 7, wherein the promotional content comprises a suggested social connection.

14. The method of claim 8, wherein the plurality of vectors further comprise user interactions within the social network.

15. The method of claim 14, wherein user interactions within the social network comprise one of: replying to content in the social network; rating content in the social network; or forwarding content in the social network.

16. The method of claim 7, wherein the predetermined degree of similarity between the user summary and the promotion summary comprises: a predetermined degree of similarity between the promotion summary and a persona summary; and a predetermined degree of similarity between the user summary and the artificial persona.
